(19) United States
(12) Patent Application Publication
(10) Pub. No.: US 2008/0179118 A1
(43) Pub. Date: Jul. 31, 2008

(54) Industrial Truck With A Support Section To Hold A Battery Block And Having A Pivoting Side Member

(75) Inventor: Udo Herrmann, Johannesburg (DE)

Correspondence Address: THE WEBB LAW FIRM, P.C., 700 KOPPERS BUILDING, 436 SEVENTH AVENUE, PITTSBURGH, PA, 15219, US

(73) Assignee: LINDE MATERIAL HANDLING GMBH, Aschaffenburg (DE)

(21) Appl. No.: 11/972,870

(22) Filed: Jan. 11, 2008

(30) Foreign Application Priority Data
Jan. 27, 2007 (DE) 10 2007 004 213.4
Sep. 21, 2007 (DE) 10 2007 045 293.6
Nov. 7, 2007 (DE) 10 2007 052 976.9

(51) Int. Cl. B60K 1/04

(52) U.S. Cl. 180/65.1

(57) ABSTRACT

An industrial truck has a vehicle frame (1) with a support section (3) that holds a battery block (4). For insertion and removal of the battery block (4), there is a lateral frame opening (3b) and a top frame opening (3a). The vehicle frame (1) has a side member (6) configured to span the support section (3). The side member (6) can be pivoted between a closed position in which it spans the support section (3) and is a component of the load-bearing structure of the vehicle frame (1) and an open position in which it allows access to the support section (3).

### CROSS REFERENCE TO RELATED APPLICATIONS

This application claims priority to German Application No. 10 2007 052 976.9 filed Nov. 7, 2007, German Application No. 10 2007 045 293.6 filed Sep. 21, 2007 and German Application No. 10 2007 004 213.4 filed Jan. 27, 2007, all of which applications are herein incorporated by reference in their entirety.

### BACKGROUND OF THE INVENTION

1. Field of the Invention

This invention relates to an industrial truck, such as a counterweighted fork-lift truck, with a battery block and a vehicle frame which has a support section that holds a battery block. For the installation and removal of the battery block, in the vicinity of the support section there is a lateral opening in the frame and a top frame opening that is adjacent to the lateral opening that can be closed by a battery cover.

2. Technical Considerations

A similar industrial truck is described in DE 101 45 991 A1. To compensate for the weakening of the vehicle frame caused by the two frame openings and by a recess that is provided in the underside of the vehicle adjacent to the lateral frame opening, a torsion box that reinforces the frame is provided in the vicinity of the support section configured to hold the battery block. The torsion box makes the vehicle frame more complex, time-consuming and expensive to fabricate.

Therefore it is an object of the invention to provide an industrial truck of the general type described above but in which the vehicle frame has a simpler construction.

### SUMMARY OF THE INVENTION

The invention teaches that the vehicle frame, in the transitional area from the top frame opening to the lateral frame opening of the support section or next to the transitional area, has a side member which is provided to span the support section. The side member can be pivoted between a closed position in which it spans the support section and an open position in which it permits access to the support section. In the closed position, the side member is a component of the load-bearing structure of the vehicle frame.

A teaching of the invention is accordingly the spanning of the open support section by a load-bearing component of the vehicle frame, and pivoting this component out of the way for replacement of the battery block. The need for a torsion box to increase stability can thereby be eliminated. Nevertheless, the battery block remains easily accessible. To replace the battery, all that is necessary is to move the pivoting side member by a simple pivoting movement from the closed position in which it stiffens the frame into the open position in which the battery block can be removed from the support section and replaced by a new battery.

The side member can be located immediately in the transitional area from the lateral frame opening to the top frame opening, i.e., in the axis of the intersection of the two planes that are perpendicular to each other and that are formed by the lateral frame opening and the top frame opening. It is also possible to provide the pivoting side member next to the transitional area. For this purpose, the side member can be located either on top, in which case it spans the top frame opening, near or next to its lateral boundary, or the side member can be located laterally, in which case it spans the lateral frame opening next to or near its top boundary.

In one advantageous embodiment of the invention, the side member is pivotally mounted on one of its ends so that it can pivot around a horizontal transverse axis.

In one development of this embodiment, the side member can be folded or pivoted backward (with reference to the longitudinal direction of the vehicle). The side member can be fastened to the counterweight of the industrial truck or to a section of the vehicle frame that is connected with the counterweight. Nevertheless, it is also possible to attach the side member in the forward area of the support section to be bridged, so that it can be folded or pivoted forwardly in the direction of travel from the closed position into the open position.

In an additional advantageous embodiment of the invention, the side member can be pivoted around a horizontal longitudinal axis, which is at a distance from the lateral frame opening toward a closed side of the frame. For this purpose, the side member, as it is pivoted from the open position into the closed position, is inserted as a unit into the support section to reinforce the frame and conversely is removed as a unit.

The side member can be fastened to a bracket which is mounted on one of its ends so that it pivots around the longitudinal axis. On the other end of the bracket is the side member, which is pivoted with it during a pivoting motion of the bracket around the horizontal longitudinal axis and can be moved back as a whole (along an orbital arc) from the closed position in which it reinforces the frame into the open position.

In one development of the invention, the side member can be connected with and/or integrated into the battery cover. When the battery cover is opened, the side member is then pivoted simultaneously from the closed position into the open position. Therefore, no additional effort is required to operate the pivoting side member.

Alternatively, it is also possible for the side member to be realized in the form of a battery cover, which can be achieved by an appropriately generous sizing of the battery cover, i.e., by the use of relatively thick sheet metal for the battery cover.

### BRIEF DESCRIPTION OF THE DRAWINGS

Additional advantages and unique features of the invention are explained in detail below and are illustrated in the accompanying schematic drawings, in which:

FIG. 1 is a perspective view of an industrial truck of the invention;

FIG. 2 is a side view of the industrial truck of FIG. 1;

FIG. 3 is a side view of one variant of ail industrial truck of the invention; and

FIG. 4 is a perspective view of an additional variant of all industrial truck of the invention.

### DESCRIPTION OF THE PREFERRED EMBODIMENTS

Ali industrial truck of the invention is illustrated in the form of a battery-powered electric counterweighted fork-lift truck (front-seat fork-lift). The industrial truck has a vehicle frame 1 with a rear-mounted counterweight 2 and a support section 3 for a battery block 4. The support section 3 is located between a forward transverse wall 1a of the vehicle frame 1 and the counterweight 2 or a rear transverse wall that is next to the counterweight 2.

In the vicinity of the support section 3, the vehicle frame 1 has a top frame opening 3a which can be covered by a pivoting battery cover (not shown in the accompanying drawings) on which there is a driver's seat. To make it possible to change the battery block 4 in the horizontal direction, the vehicle frame 1 is provided in the vicinity of the support section 3 with a lateral frame opening 3b which call be located on the left or right side of the frame 1, and in the illustrated exemplary embodiment can be closed by a battery compartment door 5. Up to this point, the construction described is similar to that described in DE 101 45 991 A1, herein incorporated by reference. In this case, the top frame opening 3a transitions into the lateral frame opening 3b or is immediately adjacent to it.

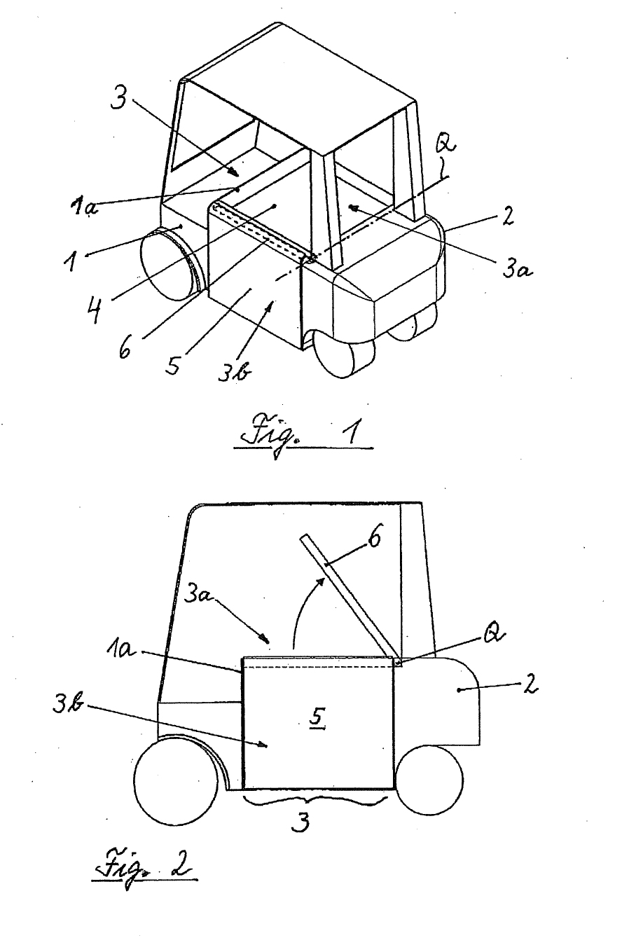

The invention teaches that a side member 6 is provided in the transitional area from the top frame opening 3a to the lateral frame opening 3b of the support section 3 or next to it. In the exemplary embodiment of the invention illustrated in FIGS. 1 to 3, this side member 6 is pivotally mounted on the rear end, viewed in the direction of travel (see FIGS. 1 and 2) so that it pivots around a horizontal transverse axis Q and can be pivoted from a horizontal closed position (parallel to transverse axis Q) into an open position.

In the closed position, the side member 6 spans the support section 3 and is thereby a component of the load-bearing structure of the vehicle frame 1. For this purpose, the side member 6 can be locked on the forward end (in the direction of travel) with the forward transverse wall 1a. The side member 6 can be locked in any conventional manner, such as by mechanically engaging a conventional locking mechanism on the forward wall 1a. In the open position, the side member 6 exposes the support section to provide unimpeded access to the battery block 4 which is located inside the vehicle frame 1 so that the battery can be replaced from the side.

The side member 6 can be connected with the battery cover so that when the battery cover is opened and closed, the side member 6 is simultaneously moved (e.g., pivoted) around the transverse axis Q from the open position into the closed position. In this context, it is also possible to integrate the side member 6 into the battery cover or to configure the side member 6 in the form of a battery cover, i.e., in the form of a surface component or a portion of the battery cover.

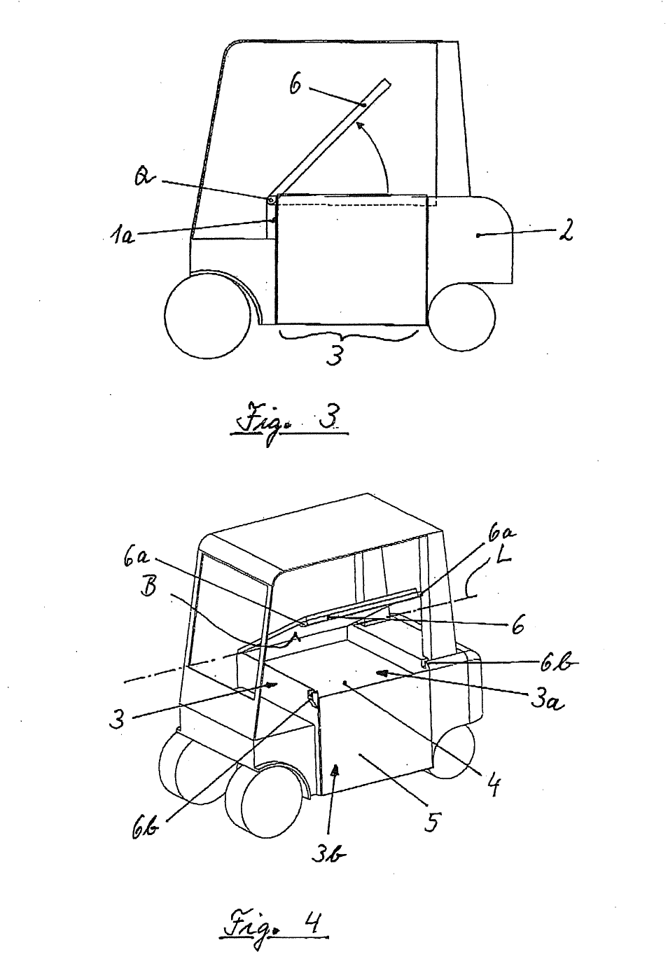

In the variant of the industrial truck illustrated in FIG. 3, the side member 6 is attached at the front, i.e., to the forward transverse wall 1a of the vehicle frame 1, so that the side member 6 call be pivoted forwardly and upwardly around the transverse axis Q. The rear end of the side member 6 can be locked in any conventional manner to a rear transverse wall (not shown) or to the counterweight 2.

In the embodiment illustrated in FIG. 4, the side member 6 is pivotable mounted to the vehicle frame 1 not on one of its ends but is fastened to a bracket which in the illustrated exemplary embodiment is formed by the battery cover B attached (e.g., pivotally attached) to the closed side of the vehicle frame 1. The battery cover B is thereby mounted so that it pivots around a horizontal longitudinal axis L which is located on the closed side of the vehicle frame 1, i.e., at a distance from the lateral frame opening 3b in the transverse direction of the vehicle (e.g., on the side of the vehicle opposite the lateral frame opening 3b). When the battery cover B is opened, the side member 6 is therefore moved as a whole away from the support section 3 and, vice-versa, when the battery cover B is closed it is inserted, also as a whole, into the support section 3 to reinforce the frame 1. To solidly span the support section 3 in the closed position and thus reinforce the frame 1, the side member 6 is provided on both ends with axial pins 6a which in the closed position engage in recesses 6b in the vehicle frame 1.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and ally and all equivalents thereof.

What is claimed is:

1. An industrial truck, comprising:
a vehicle frame having a support section to hold a battery block;
a lateral frame opening and a top frame opening which is adjacent to the lateral frame opening on the top and can be closed by a battery cover; and
a side member located in a transitional area from the top frame opening to the lateral frame opening of the support section or next to the transitional area, the side member configured to span the support section, wherein the side member is pivotable between a closed position in which it spans the support section and is a component of a load-bearing structure of the vehicle frame and an open position in which it allows access to the support section.

2. The industrial truck as recited in claim 1, wherein the side member is pivotally mounted on one end so that it is pivotable around a horizontal transverse axis.

3. The industrial truck as recited in claim 2, wherein the side member pivots rearwardly with reference to a longitudinal direction of the vehicle.

4. The industrial truck as recited in claim 1, wherein the side member is pivotable around a horizontal longitudinal axis which is at a spaced distance from the lateral frame opening in a direction of a closed side of the frame.

5. The industrial truck as recited in claim 4, wherein the side member is fastened to a bracket, which is mounted on one of its ends so that it is pivotable around the longitudinal axis.

6. The industrial truck as recited in claim 1, wherein the side member is connected with the battery cover.

7. The industrial truck as recited in claim 1, wherein the side member is in the form of the battery cover.

8. The industrial truck as recited in claim 1, wherein the side member is integrated into the battery cover.
